(19) United States
(12) Patent Application Publication
(10) Pub. No.: US 2008/0033323 A1
(43) Pub. Date: Feb. 7, 2008

(54) Use of an Extracorporal Shock Wave Applicator

(75) Inventors: Romed Meirer, Innsbruck (AT); Florian Kamelger, Innsbruck (AT)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Sanuwave, Inc. a Delaware corporation

(21) Appl. No.: 10/588,192

(22) PCT Filed: Feb. 2, 2005
(86) PCT No.: PCT/EP05/50448

§ 371 Date: Sep. 26, 2007

Related U.S. Application Data
(60) Provisional application No. 60/582,468, filed on Jun. 24, 2004.

(30) Foreign Application Priority Data
Feb. 2, 2004 (AT) A 145/2004

(51) Int. Cl. A61H 1/00

(52) U.S. Cl. 601/1

(57) ABSTRACT

Described is the use of an extracorporal shock wave applicator for providing a device for the treatment of soft tissue disorders in human and animal bodies.

The present invention relates to a method for the treatment of soft tissue disorders.

Since its introduction over 20 years ago ESW therapy has been the method of choice in urolithiasis. The shock waves (pressure waves), which are generated outside the body, can be focused at a specific site within the body. These waves travel through fluid and soft tissue and their effects occur at sites where there is a change in impedance, such as the bone-soft tissue interface. Mainly three mechanisms to generate a focused shock wave are used in medicine: piezoelectric, electromagnetic, and electrohydraulic. All mentioned mechanisms convert electrical energy into a pressure wave within a fluid medium (Gerdesmeyer et al., 2002). To allow the propagation of the waves from the shock wave applicator into the body, a contact medium has to be applied. In clinical practice ultrasonic gel as contact medium is routinely used.

The common use for shock waves is to break kidney stones into fragments that can then be passed through the urinary passage. It is known that shock waves can also increase cellular permeability, stimulate cellular division and stimulate cytokine production by cells (Wang F S et al., 2000; Kusnierczak et al.; 2000). Recent studies have demonstrated that shock waves induce neovascularization at the tendon-bone junction, which in turn relieves pain and improves tissue regeneration and repairing (Wang C J et al., 2000). Extracorporeal shock wave therapy was also found to have a positive effect on the concentration of transforming growth factor-beta 1, which has a chemotactic and mitogenic effect on osteoblastic cells. There is also some evidence that shock waves may have an effect on nitric oxide synthase systems implicated in bone healing/remodelling (Cavalieri et al., 2002). Shock waves are further routinely used to treat common orthopedic conditions in humans including plantar calcaneal spurs (heel spurs) epicondylopathic humeri radialis (tennis elbow), bone spavin, navicular syndrome, and high suspensory disease among other musculoskeletal diseases. However, at this time, the mechanism or mechanisms that shock waves utilize to stimulate healing in vivo is unknown.

An important parameter for ESW therapy is the energy level utilized. Microfractures and urolithiasis for example have been seen at high energies. In studies involving the application of shock waves on bones, it was determined that relatively low energy levels do not stimulate bone formation whereas those that use high energy levels result in bone formation.

One of the main problems in clinical practice is the non-effective and slow healing of many soft tissue disorders, especially wounds. Studies in pig skin defects found that low energy shock waves stimulate skin healing whereas high-energy shock waves slowed healing (Haupt and Chvapil, 1990). In contrast to the study of Haupt and Chvapil, where a low number of impulses was applied, the present invention surprisingly revealed that the application of at least 200, preferably at least 350, most preferably at least 500 impulses allows a successful treatment of soft tissue disorders.

It is the aim of the present invention to provide means and methods for the treatment of soft tissue disorders in humans and animals. A specific object of the present invention is to provide a treatment of skin disorders, especially of wounds, and a method for accelerating healing of such disorders, specifically accelerating wound healing.

In order to achieve the above object a method for treating soft tissue disorders in human or animal bodies is provided wherein said disorders are treated by the application of extracorporal shock waves. It could be shown with the present invention that shock waves cannot be used only for treating urolithiasis, i.e. disrupting solid particles with clear three-dimensional shapes deep inside the body, but that also for disorders being located in or on the surface of the body or in a region closely under the skin beneficial effects may be achieved. Surprisingly with the present method, the tissue for the treatment of the soft tissue disorders, especially the healing of wounds, is significantly accelerated and shows even improved results compared to the gene therapy treatment with Ad-VEGF (adenovirus expressing vascular endothelial growth factor) (Byun et al., 2001; Laitinen et al., 1998).

In the scope of the present invention “soft tissues” are defined as all types of tissues from the skin to (but not including) viscera and related tissues (capsula fibrosa, capsula adiposa, fascia renalis etc.) and bone associated tissue (tendon, capsula articularis etc.). Therefore soft tissue disorders comprise wounds resulting from thermical, especially burns, chemical and mechanical influence, radiation derived wounds, ischemia, necrosis, especially partial skin flap necrosis, treatment of scars, accelerated scaring, regeneration of grafted skin, diabetes-related soft tissue defects and necroses, soft tissue defects related to impaired vascularization, especially arterial and venous disorders, prolonged or impaired wound healing due to infection caused by selected virus, bacteria or fungus. Defects caused by a combination of the influences mentioned above like decubitus.

In the scope of the present invention the “shock wave applicator” is the part of a shock wave apparatus which harbours the shock wave source and which gets in contact with the target. The present invention is not restricted to a certain type of shock wave applicator. Therefore all in the state of the art known shock wave sources and shock wave applicators, including fixed and mobile units, may be used (Gerdesmeyer et al., 2002; Chow and Streem, 2000; Rompe, 1997).

Usually the treatment of soft tissue disorders, especially if the skin is damaged or perforated, bears the risk of infectious contaminations. Therefore sterility is an important practical requirement for a successful treatment of such disorders being connected with skin damages with a risk of exogenous infection with pathogens or pyrogens (including microorganisms resistant to antibiotics). According to a preferred embodiment of the present invention the method is performed by applying sterile conditions by positioning a sterility barrier between the shock wave applicator and the human or animal target site. Furthermore the sterility barrier prevents also the transmission of contaminations among patients and wounds.

The unhindered passage of shock waves from the shock wave source to the target site is essential for an efficient application of the shock waves according to the present invention. Therefore the space between the shock wave applicator and the target has to be made highly permeable for shock waves. This means that any sterility barrier and/or contact agents (such as contact gels) have to be permissive for shock waves so that a sufficient portion of the shock wave energy reaches the site to be treated. An exchangeable membrane in shock wave therapy is disclosed in the European patent application EP 0 421 310 A1. Therein the membrane fulfils hygienic tasks and covers completely a therapy table harbouring an integrated shock wave apparatus.

To allow an efficient passage of the shock waves from the interface of the shock wave applicator to the target a contact medium may be used according to a preferred embodiment, especially if the applicator is not directly applied to the skin (i.e. with no significant distance to the skin). In medical practice ultrasonic gel is applied for this purpose. Of course also other known and for shock wave applications usable contact media can be applied. In the present invention the sterility barrier is surrounded at the shock wave applicator site by such a contact medium. The application of a contact medium at the body contact site depends mainly on the anatomy of the target. For certain targets (e.g. vagina and uterus) no contact medium is required.

An efficient aseptic treatment can only be achieved if the contact medium is sterile; therefore the use of a sterile contact medium is preferred.

In a preferred embodiment the sterility barrier is integrated in an exchangeable cap of or on the shockwave applicator. This sterile cap is fixed on the shock wave applicator and allows a direct use of the applicator on the body target. The cap can be one-way or autoclavable for re-use.

In a further preferred embodiment the sterility barrier is a sterile one-way or autoclavable membrane. This membrane can be used to cover the shock wave applicator and/or the body target.

In another preferred embodiment the sterility barrier is a sterile film, especially a tabular film or an adhesive film. Tabular films are routinely used e.g. in ultrasonic diagnostics. Adhesive films as described in the EP 0 051 935 B1, EP 0 178 740 B1 and EP 0 196 459 B1 and consisting e.g. of polyurethane, are used in medical practice as incise drapes in surgery or to cover wounds in order to prevent contaminations with pathogens.

In a further preferred embodiment the sterility barrier is a sterile gel pad. Such sterilisable gel pads are routinely used in ultrasonic diagnostics to display superficial anatomic structures.

According to a preferred embodiment of the present invention the sterility barrier may also consist of a probe cover, especially endocavity latex probe cover. Such latex probe covers are used for example in ultrasonic diagnostics for the examination of the cavity of the uterus of a female patient.

According to the present invention pulsed shock waves are applied during treatment in a total number of 350 to 5000, preferably 500 to 3500, more preferably 500 to 3000 impulses. Specifically for treating wounds the application of 500 to 3000 impulses has been proven to be specifically advantageous.

The applied energy flux density is another important parameter in treating shock wave therapy. Soft tissue disorders are preferably treated with an energy flux density ranging from 0.05 mJ/mm² to 0.3 mJ/mm², especially 0.1 mJ/mm² to 0.2 mJ/mm².

Soft tissue disorders, especially skin disorders, cover often large areas of the human and animal body. The method according to the present invention is specifically suited for the treatment of such disorders, especially wounds spreading over large skin areas, such as burns and cauterisation. Therefore, according to the present invention, the treated area covers at least 1 cm², preferably at least 5 cm², most preferably at least 10 cm².

According to another aspect, the present invention provides a kit for the treatment of soft tissue disorders in humans and animals with extracorporal shock waves comprising
a shock wave applicator,
a shock wave permeable sterility barrier and
a contact medium

According to a further aspect, a device for treating soft tissue disorders comprising a shockwave applicator, a contact medium and an exchangeable sterility cap is provided, wherein the contact medium is provided in a container or volume between the applicator and the sterility cap.

The present invention is further illustrated by the following examples and figures, without being restricted thereto:

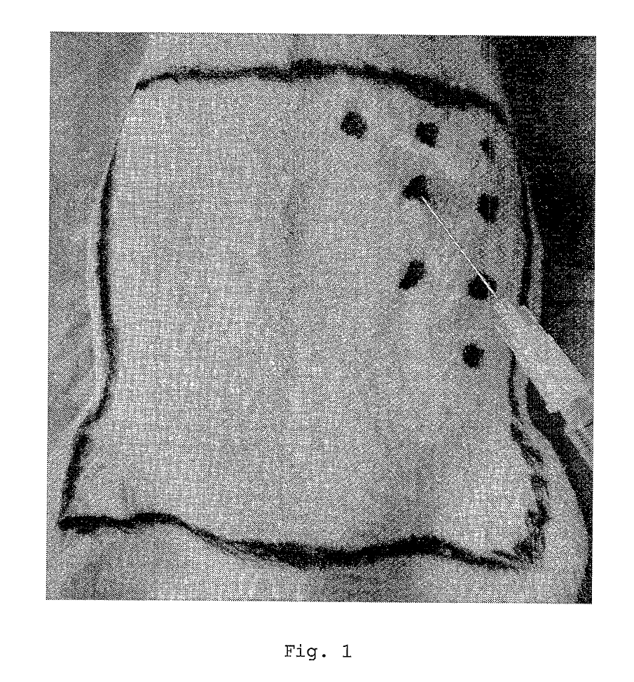

FIG. 1 reveals the Ad-VEGF (adenovirus expressing vascular endothelial growth factor) injection sites (spots) in the abdominal region of a rat of the Ad-VEGF group;

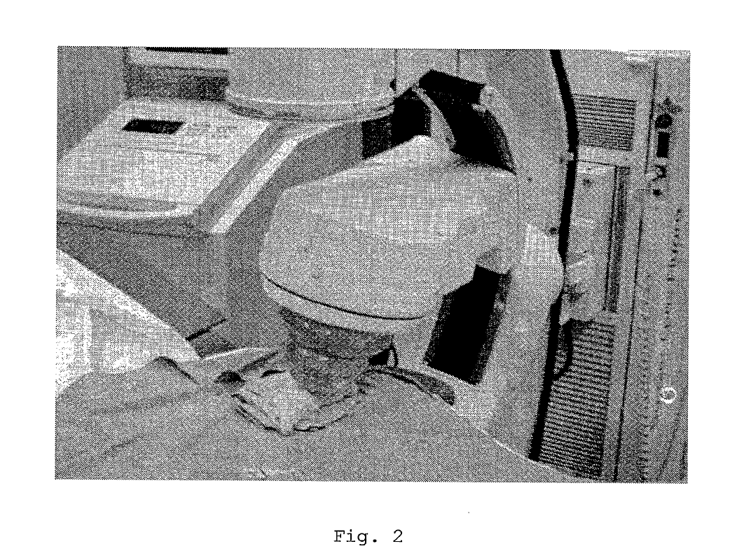

FIG. 2 shows the experimental setup during the shock wave application;

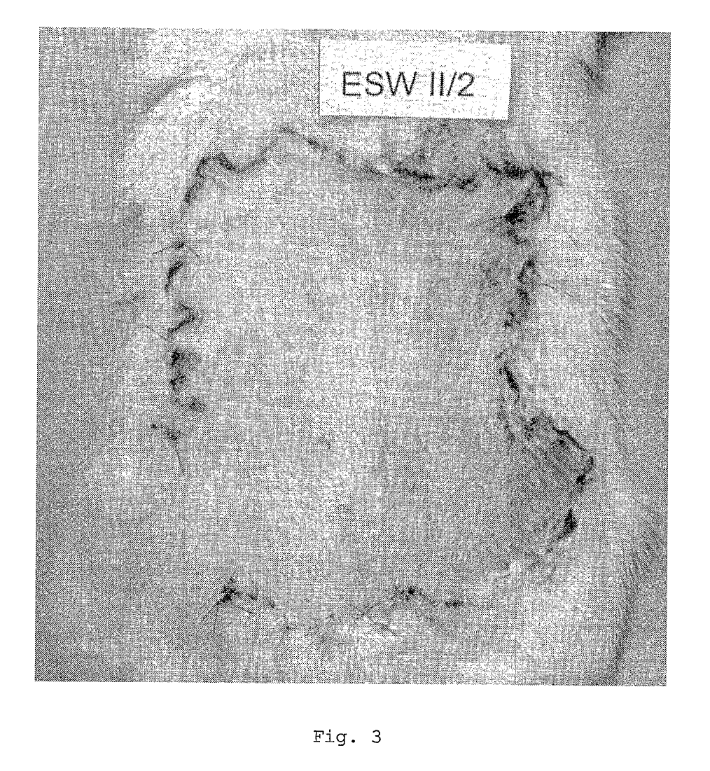

FIG. 3 shows the abdominal region of a rat of the shock wave treated ESW group at day 7, clearly indicating only small areas of necrotic zones;

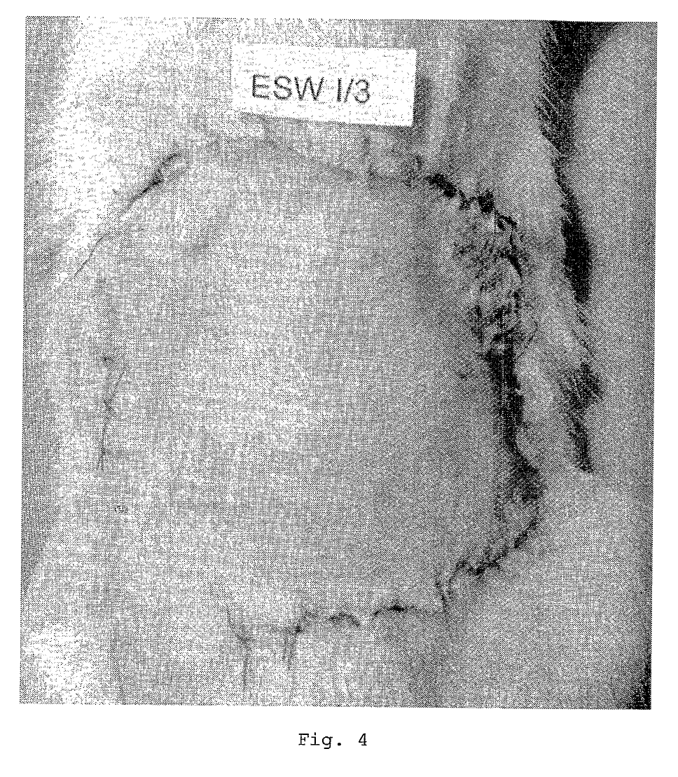

FIG. 4 shows the abdominal region of a rat of the Ad-VEGF group at day 7, indicating larger necrotic areas compared to samples of the ESW group and

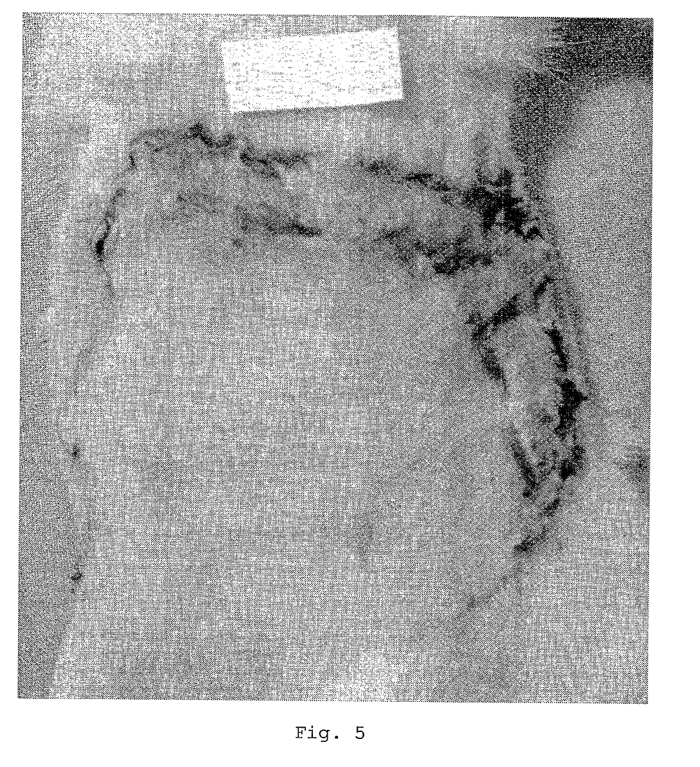

FIG. 5 shows the abdominal region of a rat of the control group at day 7, indicating a large area of necrotic skin.

### EXAMPLES

### Example 1

### Extracorporal Shock Wave Therapy in Plastic and Reconstructive Surgery

Partial skin flap necrosis caused by inadequate arterial inflow or insufficient venous outflow is a significant problem in plastic and reconstructive surgery (Kerrigan, 1983). If flap necrosis occurs, subsequent management often includes time-consuming and repetitive dressing changes aimed at promoting healing by secondary intention or even secondary reconstructive procedures. Several methods, for instance, treatment with hyperbaric oxygen, have been used in an attempt to increase blood supply and tissue perfusion in compromised tissues (Pellitteri et al., 1992). The potential of therapeutic agents, including a variety of growth factors, to stimulate the development of angiogenesis in ischemic skin flaps has aroused considerable interest (Khouri et al., 1991; Haws et al., 2001). However, the need for high initial doses and daily applications as well as short half-life of these growth factors suggests that an important aspect of their efficacy is the means of delivery. For this reason, recent investigations on therapeutic angiogenesis have mainly focused on the use of various gene therapy techniques for growth factor delivery (Lubiatowski et al., 2002; Machens et al., 2003). Although considerably effective, potential side effects and the cost intensiveness of these techniques represent some of the drawbacks of this approach.

The feasibility of enhancing epigastric skin flap survival with extracorporal shock wave treatment was investigated.

### Materials and Methods

Twenty male Sprague-Dawley rats weighing 300 to 500 g were used in this study and were divided into two groups (ESW-group, Control group) of ten rats each. The rats were anesthetized with intraperitoneal injection of sodium pentobarbital (50 mg/kg).

### The Epigastric Skin Flap Model

The previously described epigastric skin flap model was used in this example with some modification of the flap design (Kryger et al., 2000; Petry and Wortham, 1984). Based solely on the right inferior epigastric vessels, the contralateral distal corner of the flap represents the random portion which predictably undergoes necrosis, amounting to about 30 percent of the total flap area. The flap is designed in such a way that the lateral branch of the right epigastric artery is excluded and the flap is supplied by the medial arterial branch alone (Padubidri and Browne, 1997).

### Operative Technique

The rats were first anesthetized and the epigastric flap measuring 8×8 cm was outlined on abdominal skin extending from the xiphoid process proximally and the pubic region distally, to the anterior axillary lines bilaterally. The flap was elevated after incising the distal and lateral borders. Then the inferior epigastric vessels were located bilaterally. The right inferior epigastric artery and vein were left intact, whereas the left inferior epigastric vessels were ligated and divided. Finally, the proximal border of the flap was incised to create a skin island flap pedicled on the right inferior epigastric vessels. Then, the flap was sutured back to its native configuration by using interrupted 4-0 non-absorbable sutures.

### ESW Treatment

Immediately after the surgical intervention the anesthetized rats were placed in a supine position. The ultrasound transmission gel (Pharmaceutical Innovations Inc, NJ, USA) was used as contact medium between the ESW apparatus and skin. ESW treatment with 750 impulses at 0.15 mJ/mm² (Epos Fluoro Dornier MedTech Gmbh, Wesslingen, Germany) was given to the left upper corner of the flap. This area represents the random portion of the flap, which according to literature predictably undergoes necrosis.

### Follow-up

Follow-up evaluation was performed on postoperative day 7. The animals were anesthetized and after standardized digital pictures of the flaps were taken and transferred to the computer, they were killed with an overdose of intraperitoneal pentobarbital (100 mg/kg. The following flap zones were defined for surface area measurement: necrotic zone and total flap area (defined by surgical borders). Surface area of these defined zones was measured by using Image Pro Plus Software (version 4.1, Media Cybernetics LP, Silver Spring, Md.). The results were expressed as percentage relative to total flap surface area.

### Statistical Analysis

The student's t-test was used on all pairs of interest. No correction was made for multiple testing. Results were expressed as mean±standard deviation (SD) and considered significant when p<0.05.

### Results

None of the epigastric flaps showed any signs of infection, seroma, or hematoma formation. The application of 750 impulses in the ESW group resulted in a significant reduction in the surface area of the necrotic zones of the flaps compared to the control group (ESW group: 2.25±1.8% versus control: 17.4±4.2% (p<0.05)).

### Discussion

In an attempt to understand skin flap viability and necrosis, the effects of a number of growth factors on flap survival have been examined. Several factors, most notably vascular endothelial growth factor (Lubiatowski et al., 2002; Machens et al., 2003), fibroblast growth factor (Ishiguro et al., 1994) and endothelial growth factor (Hom and Assefa, 1992) have demonstrated marked abilities to improve skin flap survival. Induction of neovascularization was thought to be the major mechanism for the improvement of flap survival by these growth factors. However, application of these growth factors is based mainly on various gene therapy techniques, and both the cost intensiveness and associated undesirable side effects represent some of the major drawbacks of this approach (Vajanto et al., 2002).

Recent results of animal studies suggest that ESW treatment stimulates the early expression of angiogenesis-related growth factors. According to Wang (2003), there is a significant rise of growth factors such as endothelial nitric oxide synthase, vascular endothelial growth factor and proliferating cell nuclear antigen inducing ingrowth of new vessels. In similar studies Wang et al. (2003) demonstrated that shock wave treatment is effective in promoting the healing of fractures and injuries at the tendon bone junction most probably by stimulated expression of the growth factors mentioned above and tumour growth factor-β1. All of these studies mainly focused on orthopaedic problems. The potential use of ESW therapy in plastic surgery was investigated. As loss of flap due to poor circulation is a major problem confronting plastic surgeons in reconstructive surgical procedures, the effectiveness of ESW treatment on skin flaps in the promotion of angiogenesis and thus in flap survival was assessed.

Despite success in the treatment of certain orthopaedic disorders (Haupt, 1997; Rompe et al., 1996) the exact mechanism of shock wave therapy is not yet known. According to available literature the incidence of shock wave complications varied significantly with the location of treatment and the amount of shock wave energy (Wang et al., 2002). The ESW treatment consisted of 750 impulses at 0.15 mJ/mm², which represents a low-dose treatment, without encountering any complications. On the contrary, impressively small necrotic zones of epigastric skin flaps representing 2.25% of the total flap area were achieved. This is the first time that such results have been described. ESW treatment stimulates a cascade of growth factors interacting in a complex and more efficient way than a single agent does. Although further studies have to be conducted to determine the exact level of growth factors after ESW treatment, this technique seems to represent a feasible and cost effective method to improve blood supply in ischemic tissue.

### Example 2

### Dose Finding Studies

The dose dependent effect of ESW therapy on skin flap survival in a rat model, using the epigastric skin flap, based solely on the right inferior epigastric vessels was evaluated by using similar methods as described in example 1. In contrast to the previous example a portable shock wave device was used (Evotron, HMT High Medical Technologies AG, Lengwil, Switzerland).

42 male Sprague-Dawley rats were divided into 7 groups (SW-group I-VI, Control-group) of 6 rats each. Immediately after surgery the ESW was administered 10 (group I), 200 (group II), 500 (group III), 1500 (group IV), 2500 (group V), 5000 (group VI) impulses at 0.11 mJ/mm², whereas the control group received no treatment. Flap viability was evaluated on day 7 after the operation. Standardized digital pictures of the flaps were taken and transferred to the computer, and necrotic zones relative to total flap surface area were measured and expressed as percentages. Overall, significantly smaller areas of necrotic zones were noted in the group III-V compared to group I, II, VI and the control-group (p<0.05). Whereas among Groups III to V comparable results were obtained (p<0.05), ESW treatment in group I and II demonstrated to be uneffective as the areas of necrosis did not show any significant difference compared to the control group. ESW treatment in group VI showed significant larger areas of necrosis compared to the control group and all the other ESW groups (p<0.05).

Recapitulating, ESW treatment with 500, 1500 and 2500 impulses enhanced epigastric skin flap survival significantly. ESW treatment with 10 and 200 impulses had no effect compared to the control group. ESW treatment with 5000 impulses at 0.11 mJ/mm² resulted in a significantly larger area of necrosis compared to the untreated control group.

### Example 3

### Comparison of Epigastric Skin Flap Survival in Gene Therapy With Vascular Endothelial Growth Factor (VEGF) and Extracorporal Shock Wave Therapy in a Rat Model

In this example the effectivity of adenovirus mediated VEGF and ESW in enhancing epigastric skin flap survival was compared.

### Materials and Methods

Thirty male Sprague-Dawley rats weighing 300 to 500 g were used in this study and were divided into three groups (ESW-group, VEGF-group, Control-group) of ten rats each. Anesthesia was performed by intraperitoneal injection of 50 mg/kg ketamine (Ketanest 100 mg/ml; Fort Dodge Laboratories, IA, USA) and 1.3 g/kg bw Xylazine (Rampun 20 mg/ml; Bayer Corp., KS) with periodic supplementation as needed.

### Group I: Treatment with Ad-VEGF

An E1/E3 deleted adenovirus expressing VEGF was received as a gift from Genvec Inc. (Gaithersburg, Md., USA). The adenovirus was dialyzed against phosphate saline, diluted in 5% glycerol/phosphate-buffered saline, aliquoted, and frozen at −70° C. until ready for use. Just before animal injections, 10⁸ plaque-forming units, as an expression for the viral titer, were diluted to a final volume of 0.3 ml of 0.9% sodium chloride and loaded into a 1-ml syringe with a 27-gauge needle. Animals were anesthetized as described above and abdominal hair was shaved with an electric razor and then prepped with Betadine and alcohol. A flap measuring 8 cm×8 cm was outlined with a permanent marker on abdominal skin extending from the xyphoid process proximally and the pubic region distally, to the anterior axillary lines bilaterally. Injections were made to the subdermal space with seven points into the left upper corner of the flap (FIG. 1).

### Group II: Treatment With ESW

Immediately after the surgical intervention (see below for details) the anesthetized rats were placed in a supine position. The ultrasound transmission gel (Pharmaceutical Innovations Inc, NJ, USA) was used as contact medium between the ESW apparatus and skin. ESW treatment with 2500 impulses at 0.15 mJ/mm² (Epos Fluoro Dornier MedTech Gmbh, Wesslingen, Germany) was given to the left upper corner of the flap (FIG. 2). This area represents the random portion of the flap, which according to literature predictably undergoes necrosis.

### Group III: Control Group

In one group of animals the flap was raised but neither injections were given nor a treatment with ESW was carried and this group was designated as a control group.

### The Epigastric Skin Flap Model

The epigastric skin flap model in this study has been previously described with a modification in flap design (Padubidri and Browne, 1997). Based solely on the right inferior epigastric vessels, the contralateral distal corner of the flap represents the random portion which predictably undergoes necrosis, amounting to about 30 percent of the total flap area. The flap is designed in such a way that the lateral branch of the right epigastric artery is excluded and the flap is supplied by the medial arterial branch alone.

### Surgical Technique

The rats were anesthetized and the epigastric flap measuring 8×8 cm was outlined on abdominal skin. The abdominal skin of the rats was shaved with an electric razor and then prepped with Betadine and alcohol. The flap was elevated after incising the distal and lateral borders by sharp dissection (Shafighi et al. 2003). Then the inferior epigastric vessels were located bilaterally. The right inferior epigastric artery and vein were left intact, whereas the left inferior epigastric vessels were ligated and divided. Finally, the proximal border of the flap was incised to create a skin island flap pedicled on the right inferior epigastric vessels. Then, the flap was sutured back to its native configuration by using interrupted 4-0 non-absorbable sutures.

### Evaluation

Follow-up evaluation was performed on postoperative day 7. The animals were anesthetized and after standardized digital pictures of the flaps were taken and transferred to the computer, they were killed with an overdose of intraperitoneal pentobarbital (100 mg/kg). The following flap zones were defined for surface area measurement: necrotic zone and total flap area (defined by surgical borders). Surface area of these defined zones was measured by using Image Pro Plus Software (version 4.1, Media Cybernetics LP, Silver Spring, Md.). The results were expressed as percentage relative to total flap surface area.

### Statistical Analysis

The Kruskall-Wallis test was used to test the equality of median percent necrotic area between the three groups overall. Two-tailed Wilcoxon rank sum test was used on all pairs of interest. No correction was made for multiple testing. Results were expressed as mean ±SD and considered significant when p<0.05.

### Results

None of the epigastric flaps showed any signs of infection, seroma, or hematoma formation.

At day 7, significantly smaller areas of necrotic zones were noted in the ESW-group (FIG. 3), and the Ad-VEGF-group (FIG. 4) compared with the control-group (FIG. 5) (ESW-group: 2.25±1.8% versus control group: 19.3±4.1% (p<0.05); Ad-VEGF-group: 9.5±1.3% versus control-group 19.3±4.1% (p<0.05)). Furthermore in the ESW-group areas of necrotic zones were significantly smaller than in Ad-VEGF-group (ESW-group: 2.25±1.8% versus Ad-VEGF-group: 9.5±1.3% (p<0.05)).

### Discussion

In an attempt to prevent ischemia and consecutive skin flap necrosis the effects of a number of growth factors on flap survival have been examined. Several factors, most notably VEGF (Lubiatowski et al., 2002; Machens et al., 2003) have demonstrated marked abilities to improve skin flap survival by inducing neovascularization. However the formation of mature blood vessels additionally requires many other growth factors that are not endothelium specific, such as members of the platelet-derived growth factor, fibroblast growth factor or transforming growth factor-β families (Henry, 1999).

Recent results of animal studies suggest that ESW treatment stimulates the early expression of a wide array of these necessary growth factors endogenously. Wang (2003) stated that there is a significant rise of growth factors such as endothelial nitric oxide synthase, vascular endothelial growth factor and proliferating cell nuclear antigen inducing ingrowth of new vessels. In a consecutive study Wang et al. (2003) demonstrated that shock wave treatment is effective in promoting the healing of fractures and injuries by stimulated expression of the growth factors mentioned above and tumour growth factor-β16. The effect of gene therapy with VEGF and SW therapy on skin flap survival was compared.
The adenovirus-mediated gene therapy using VEGF enhanced epigastric skin flap survival significantly compared with the control. Several studies have already demonstrated the successful use of adenovirus vector encoding for VEGF in experimental and clinical settings (Byun et al., 2001; Laitinen et al., 1998). Surprisingly the ESW-group showed significantly smaller necrotic zones compared to the Ad-VEGF-group. This is the first time that such small necrotic zones of epigastric skin flaps representing 2.25% of the total flap area have been described.
Like in the VEGF-group none of the epigastric flaps treated with SW showed any signs of infection, seroma, or hematoma formation. According to available literature the incidence of shock wave complications varied significantly with the location of treatment and the amount of shock wave energy (Wang et al., 2002). As the ESW treatment consisted of 2500 impulses at 0.15 mJ/mm2, which represents a low-dose treatment, no complications were encountered. This could represent a possible advantage in the use of ESW compared to the use of Ad-VEGF as it has been demonstrated by some studies that the use of adenovirus may be associated with inflammatory reaction (Newman et al., 1995; Tripathy et al., 1996). Long-term safety of incorporating a virus vector into the host genome also remains one of the major concerns in virus-mediated gene therapy.
This ESW technique represents a feasible and cost effective method to improve blood supply in ischemic tissue. As ESW is already successfully used in the treatment of urologic and orthopaedic disorders its use in plastic surgery may soon become an important adjunct.

### Example 4

### Comparison of the Effects of Three Focused Shock Waves and the Unfocused Pulsed Wave in Epigastric Skin Flap Survival

Aim of this example is to show whether there can be seen differences between the application of the four mentioned generation principles regarding the effect on flap necrosis in the epigastric flap model.

Industry provides two main generation methods of extracorporal shock waves: focused (ballistic) and unfocused (unballistic, radial) shock waves. Focused shock waves can be combined under the denomination “Extracorporal shock wave therapy” (ESWT) and can be classified into three main methods of generation: electrohydraulic, electromagnetic and piezoelectric principles. Unballistic shock waves are used for the so called “Unfocused Pressure Pulse Therapy” (UPPT).

50 male Spragew-Dawley-rats were divided into 5 groups of 10 animals each. An epigastric skin flap, based solely on the right epigastric vessels, was made and, immediately after surgery, treated with 500 pulses of ESW (0.11 mJ/mm²). Group 1 was treated with electrohydraulically (Evotron, HMT), group 2 with electromagnetically (Epos Fluoro, Dornier), group 3 with piezoelectrically (Piezoson 100, Wolf) and group 4 with radially (Swiss DolorClast, EMS) generated shock waves. Group 5 served as control group and did not receive any treatment. Flap viability was evaluated on day 7 after the operation. Standardized digital pictures of the flaps were taken and transferred to the computer, and necrotic zones relative to total flap surface area were measured and expressed as percentages.

Group 1 showed a surface area of the necrotic zones of 6.1% (±6.3), group 2 of 6.4% (±4.6), group 3 of 16.6% (±8.4) and group 4 of 14.4% (±6.7). Control group 5 showed necrotic areas of 26.8 (±18.5). Differences between the four used methods were statistically significant with p<0.05.

It could be shown that different shock wave generation principles show significant increases of blood supply in a rat animal model, using the epigastric skin flap, based solely on the right epigastric vessels. It could be demonstrated an improvement of flap survival in all groups compared to the control group. However, electrohydraulical and elecromagnetical shock waves increased the flap survival significantly. The both mentioned principles seem to be convenient for shock wave treatment of the skin, but also piezoelectrical shock waves as well as unfocused pulsed waves can be used for a succesful shock wave treatment of soft tissue disorders.

### Example 5

### Shock Wave Therapy—An Innovative Treatment for Chronic Wounds in Diabetes Patients

Chronic wounds of the lower leg and the foot in diabetes are common. Tissue ischemia and poor management cause diabetic wounds to heal slowly. In this letter we present the first four diabetic patients out of a controlled trial with chronic wounds who were treated with extracorporal shock wave (ESW) therapy. In concordance with the patients we treated the wounds at day 1, 4, 8 and 11 with ESW therapy. Ultrasound transmission gel was used as contact medium between the ESW applicator and skin. The ESW treatments consisted of 500 impulses at 0.11 mJ/mm² each. Consecutively fine mesh gauze was applied as wound dressing. The surface areas of the wounds were documented twice a week by digital fotography and by Visitrak (Smith & Nephew). In between 2 weeks all wounds healed completely. No recurrence could be seen in the 8 week follow up period.

### Example 6

### Shock Wave Therapy: An Innovative Treatment Method for Partial Thickness Burns

In a majority of cases of deep partial—thickness burns skin grafting with early excision is indicated. A young man with deep partial thickness burns at his right forearm was treated with shock wave therapy. The burn healed uneventful without any scarring. No recurrence could be seen in the 6 months follow up period.

### REFERENCES

Byun J., Heard J., Huh J., et al. J. Mol. Cell. Cardiol. 33:295, 2001
Cavalieri E, Russo S, Corrado E A, et al. Proceedings. 5th Congress Int Soc for Musculoskeletal Shockwave Therapy 2002; 20.
Chow G K, Streem S B. Urol Clin North Am 2000; 27:315-322.
Gerdesmeyer L, Maier M, Haake M, Schmitz C. Orthopäde 2002; 31:610-617.
Haupt G, Chvapil M. J Surg Res; 1990 49:45-48.
Haupt G. J Urol 1997; 158: 4-11.
Haws M J, Erdman D, Bayati S, Brown R E, Russell R C. J Reconstr Microsurg 2001; 17: 39-42.
Henry, T. D. Br. Med. J. 318:1536, 1999
Hom D B, Assefa G. Arch Otolaryngol Head Neck Surg 1992; 118: 624-8.
Ishiguro N, Yabe Y, Shimizu T, Iwata H, Miura T. Ann Plast Surg 1994; 32: 356-60.
Kerrigan C L. Plast Reconstr Surg 1983; 72: 766-77.
Khouri R K, Brown D M, Leal-Khouri S M, Tark K C, Shaw W W. Br J Plast Surg 1991; 44: 585-8.
Kryger Z, Zhang F, Dogan T, Cheng C, Lineaweaver W C, Buncke H J. Br J Plast Surg 2000; 53: 234-9.
Kusnierczak D, Brocai DRC, Vettel U, et al. Proceedings. 3rd Congress Int Soc for Musculoskeletal Shockwave Therapy 2000; 96.
Laitinen, M., Makinen, K., Manninen, H., et al. Hum. Gene Ther. 9:1481, 1998
Lubiatowski P, Goldman C K, Gurunluoglu R, Carnevale K, Siemionow M. Plast Reconstr Surg 2002; 109: 1986-93.
Machens H G, Salehi J, Weich H et al. J Surg Res 2003; 111: 136-42.
Newman, K. D., Dunn, P. F., Owens, J. W., et al. J Clin. Invest. 96:2955, 1995
Padubidri A N, Browne E. Ann Plast Surg 1997; 39: 500-4.
Pellitteri P K, Kennedy T L, Youn B A. Arch Otolaryngol Head Neck Surg 1992; 18: 1050-4.
Petry J J, Wortham K S. Plast Reconstr Surg 1984; 74: 410-3.
Rompe J, Hope C, Kullmer K, Heine J, Burger R. J Bone Joint Surg 1996; 78: 233-7.
Rompe, J.-D. Extrakorporale Stosswellentherapie; Chapman & Hall GmbH, Weinheim, 1997, ISBN 3-8261-0138-3
Shafighi M, Huemer G M, Meirer R, Piza-Katzer H. Plast. Reconstr. Surg. 112: 1507, 2003
Tripathy S K, Black H B, Goldwasser E, and Leiden J M. Nat Med 2:545, 1996
Vajanto I, Rissanen T T, Rutanen J et al. J Gene Med 2002; 4: 371-80.
Wang C J. Chang Gung Med J 2003; 26: 220-32.
Wang C J, Wang F S, Yang K D et al. J Orthop Res 2003; 21: 984-9.
Wang C J, Paich, Avery S Y. Proceedings. 3rd Congress Int Soc for Musculoskeletal Shockwave Therapy 2000; 96.
Wang C J, Huang H Y, Yang K, Wang F S, Wong M. Injury 2002; 33: 439-46.
Wang F S, Keunder K D, Wang C J. Proceedings. 3rd Congress Int Soc for Musculoskeletal Shockwave Therapy 2000; 99.

1. Use of an extracorporal shock wave applicator for providing a device for the treatment of soft tissue disorders in human and animal bodies.

2. Use of a device according to claim 1, wherein at least 200, preferably at least 350, most preferably at least 500 impulses are applied by said extracorporal shock wave applicator.

3. Use of a device according to claim 1 or 2, wherein a shock wave permeable sterility barrier is positioned between the shock wave applicator and the body.

4. Use of a device according to any one of claims 1 to 3, wherein the shock waves are propagated by a contact medium.

5. Use of a device according to any one of claims 1 to 4, wherein the soft tissue disorders comprise wounds resulting from thermical, especially burns, chemical and mechanical influence, radiation derived wounds, ischemia, necrosis, especially partial skin flap necrosis, treatment of scars, accelerated scaring, regeneration of grafted skin, diabetes-related soft tissue defects and necroses, soft tissue defects related to impaired vascularization, especially arterial and venous disorders, prolonged or impaired wound healing due to infection caused by selected virus, bacteria or fungus, decubitus-related disorders.

6. Use of a device according to any one of claims 1 to 5, wherein the contact medium is sterile.

7. Use of a device according to any one of claims 1 to 6, wherein the sterility barrier consists of an exchangeable cap for the applicator.

8. Use of a device according to any one of claims 1 to 6, wherein the sterility barrier consists of a membrane.

9. Use of a device according to any one of claims 1 to 6, wherein the sterility barrier consists of a film, especially a tabular film or an adhesive film.

10. Use of a device according to any one of claims 1 to 6, wherein the sterility barrier consists of a gel pad.

11. Use of a device according to any one of claims 1 to 6, wherein the sterility barrier consists of a probe cover, especially an endocavity latex probe cover.

12. Use of a device according to any one of claims 1 to 11, wherein pulsed shock waves are applied in a total number of 350 to 5000, preferably 500 to 3500, more preferably 500 to 3000 impulses.

13. Use of a device according to any one of claims 1 to 12, wherein the applied energy flux density of the produced shock waves ranges from 0.05 mJ/mm² to 0.3 mJ/mm², preferably 0.1 mJ/mm² to 0.2 mJ/mm².

14. Use of a device according to any one of claims 1 to 13, wherein the treated area covers at least 1 cm², preferably at least 5 cm², most preferably at least 10 cm².

15. A method for treating soft tissue disorders in human or animal bodies comprising administration of shock waves via an extracorporal shock wave applicator to said human or animal bodies suffering from said soft tissue disorders.

16. The method according to claim 15, characterized in that said disorders are treated by the application of at least 200, preferably at least 350, most preferably at least 500 impulses by said extracorporal shock wave applicator.

17. The method according to claim 15 or 16, wherein a sterility barrier is positioned between the shock wave applicator and the body.

18. The method according to any one of claims 15 to 17, wherein a contact medium is applied between the sterility barrier and the shock wave applicator and optionally between the sterility barrier and the body target site.

19. The method according to any one of claims 15 to 18, wherein the soft tissue disorders comprise wounds resulting from thermical, especially burns, chemical and mechanical influence, radiation derived wounds, ischemia, necrosis, especially partial skin flap necrosis, treatment of scars, accelerated scaring, regeneration of grafted skin, diabetes-related soft tissue defects and necroses, soft tissue defects related to impaired vascularization, especially arterial and venous disorders, prolonged or impaired wound healing due to infection caused by selected virus, bacteria or fungus, decubitus-related disorders.

20. The method according to any one of claims 15 to 19, wherein pulsed shock waves are applied in a total number of 350 to 5000, preferably 500 to 3500, more preferably 500 to 3000 impulses.

21. The method according to any one of claims 15 to 20, wherein the applied energy flux density of the produced shock waves ranges from 0.05 mJ/mm² to 0.3 mJ/mm², preferably 0.1 mJ/mm² to 0.2 mJ/mm².

22. The method according to any one of claims 15 to 21, wherein the treated area covers at least 1 cm², preferably at least 5 cm², most preferably at least 10 cm².

23. A kit for the treatment of soft tissue disorders in humans and animals with extracorporal shock waves comprising
a shock wave applicator,
a shock wave permeable sterility barrier and
a contact medium

24. A kit according to claim 23, characterized in that the soft tissue disorders comprise wounds resulting from thermical, especially burns, chemical and mechanical influence, radiation derived wounds, ischemia, necrosis, especially partial skin flap necrosis, treatment of scars, accelerated scaring, regeneration of grafted skin, diabetes-related soft tissue defects and necroses, soft tissue defects related to impaired vascularization, especially arterial and venous disorders, prolonged or impaired wound healing due to infection caused by selected virus, bacteria or fungus, decubitus-related disorders.

25. A kit according to claim 23 or 25, characterized in that a contact medium is provided between the sterility barrier and the shock wave applicator and optionally between the sterility barrier and the body target site.

26. A kit according to any one of claims 23 to 25, characterized in that the contact medium is sterile.

27. A kit according to any one of claims 23 to 26, characterized in that the sterility barrier consists of a membrane.

28. A kit according to any one of claims 23 to 26, characterized in that the sterility barrier consists of a film, especially a tabular film or an adhesive film.

29. A kit according to any one of claims 23 to 26, characterized in that the sterility barrier consists of a gel pad.

30. A kit according to any one of claims 23 to 26, characterized in that the sterility barrier consists of a probe cover, especially an endocavity latex probe cover.

31. A kit according to any one of claims 23 to 30, characterized in that the shock wave applicator produces a total number of 350 to 5000, preferably 500 to 3500 impulses, more preferably 500 to 3000.

32. A kit according to any one of claims 23 to 31, characterized in that the energy flux density of the produced shock waves ranges from 0.05 mJ/mm² to 0.3 mJ/mm², preferably 0.1 mJ/mm² to 0.2 mJ/mm².

33. A device for treating soft tissue disorders comprising a shockwave applicator, a contact medium and an exchangeable sterility cap.
